(19) United States
(12) Patent Application Publication
(10) Pub. No.: US 2012/0082781 A1
(43) Pub. Date: Apr. 5, 2012

(54) METHOD OF MANUFACTURING PIEZOELECTRIC VIBRATING PIECE, WAFER, PIEZOELECTRIC VIBRATOR, OSCILLATOR, ELECTRONIC APPARATUS, AND RADIO-CONTROLLED TIMEPIECE

(76) Inventor: Daishi Arimatsu, Chiba-shi (JP)

(21) Appl. No.: 13/234,917

(22) Filed: Sep. 16, 2011

(30) Foreign Application Priority Data
Sep. 30, 2010 (JP) 2010-222194

(51) Int. Cl. B05D 5/12; B05D 3/00

(52) U.S. Cl. 427/100

(57) ABSTRACT

Disclosed is a method of manufacturing a piezoelectric vibrating piece. In a resist pattern forming step, a mask member is arranged in a wafer S while a mask-side mark formed in a mask member prepared for one electrode film is aligned with wafer-side marks S3 and S4 corresponding to the mask member. The mask-side mark has exposure openings which pass through the mask member, and the shape of each of the exposure openings in plan view differs between a plurality of mask members. A plurality of wafer-side marks S3 and S4 respectively have concave portions S5 and S6, and the shape of each of the concave portions S5 and S6 differs between a plurality of wafer-side marks S3 and S4 such that the wafer-side marks S3 and S4 have the same shape as the exposure openings in the corresponding mask member in plan view. In the resist pattern forming step, the concave portions S5 and S6 are exposed from the exposure openings to align the mask-side mark with the wafer-side marks S3 and S4.

### RELATED APPLICATIONS

This application claims priority under 35 U.S.C. §119 to Japanese Patent Application No. 2010-222194 filed on Sep. 30, 2010, the entire content of which is hereby incorporated by reference.

### BACKGROUND OF THE INVENTION

1. Field of the Invention

The present invention relates to a method of manufacturing a piezoelectric vibrating piece, a wafer, a piezoelectric vibrator, an oscillator, an electronic apparatus, and a radio-controlled timepiece.

2. Description of the Related Art

In recent years, a piezoelectric vibrator which has a piezoelectric vibrating piece using crystal or the like is used in a mobile phone or a portable information terminal apparatus as a time source, a timing source of a control signal, a reference signal source, or the like. This type of piezoelectric vibrating piece includes a piezoelectric plate which is made of a piezoelectric material, and an electrode portion which vibrates the piezoelectric plate when a voltage is applied. The electrode portion has a plurality of electrode films which are laminated on the outer surface of the piezoelectric plate and have different patterns.

In regard to this piezoelectric vibrating piece, in general, a plurality of piezoelectric vibrating pieces are manufactured using a wafer at one time. As an example of a manufacturing method, for example, a method described in JP-A-2007-142795 is used. According to this method, after the exterior shape of a piezoelectric substrate and an alignment marker are formed in a wafer, the electrode portion is formed.

When forming the electrode films of the electrode portion, first, a resist film is applied onto the wafer, and a photomask is arranged on the wafer to pattern the resist film, thereby forming a resist pattern. Thereafter, an electrode film is formed on the basis of the resist pattern. In this course, when the photomask is arranged on the wafer, the photomask is aligned on the wafer using the alignment marker, making it possible to form the electrode portion with high precision.

As described above, when the electrode portion has a plurality of electrode films having different patterns, in order to form resist patterns having different shapes to correspond to the electrode films, it is necessary to use a plurality of types of photomasks.

In the method of manufacturing a piezoelectric vibrating piece in the related art, however, a photomask of a different type from a photomask which should be originally arranged may be arranged to form a resist pattern. In this case, the electrode film is not patterned in a desired pattern, and the wafer is disused or the like, causing an increase in manufacturing cost.

### SUMMARY OF THE INVENTION

The invention has been finalized in consideration of the above-described situation, and an object of the invention is to provide a method of manufacturing a piezoelectric vibrating piece capable of preventing a resist pattern from being formed in a state where a mask member is erroneously arranged, thereby achieving low cost.

In order to solve the above-described problem, the invention suggests the following means.

An aspect of the invention provides a method of manufacturing a piezoelectric vibrating piece which forms a piezoelectric vibrating piece. The piezoelectric vibrating piece includes a piezoelectric plate which is made of a piezoelectric material, and an electrode portion which vibrates piezoelectric plate when a voltage is applied. The electrode portion has a plurality of electrode films which are laminated on the outer surface of the piezoelectric plate and have different patterns. The method includes an electrode forming step of forming the electrode portion in a wafer in which the outline shape of the piezoelectric plate is formed. The electrode forming step has a plurality of electrode film forming steps of forming the plurality of electrode films in the wafer by a photolithography technique. Each of the plurality of electrode film forming steps has a resist pattern forming step of applying a resist film onto the wafer, arranging a mask member prepared for one electrode film to be formed in the electrode film forming step from among a plurality of mask members prepared for the electrode films in the wafer, and irradiating light through the mask member to form a resist pattern. In the resist pattern forming step, the mask member is arranged in the wafer while a mask-side mark formed in the mask member prepared for one electrode film is aligned with wafer-side marks corresponding to the mask member from among a plurality of wafer-side marks formed in the wafer. The mask-side mark has exposure openings which pass through the mask member, and the shape of each of the exposure openings in plan view differs between the plurality of mask members. The plurality of wafer-side marks are formed by concave portions, and the shape of each of the concave portions in plan view differs between the plurality of wafer-side marks such that the wafer-side marks have the same shape as the exposure openings in the mask member in plan view. In the resist pattern forming step, the concave portions are exposed from the exposure opening to align the mask-side mark with the wafer-side marks.

Another aspect of the invention provides a wafer which is used for the method of manufacturing a piezoelectric vibrating piece. A plurality of wafer-side marks corresponding to the plurality of mask members are formed. Each of the plurality of wafer-side marks has concave portions, and the shape of each of the concave portions in plan view differs between the plurality of wafer-side marks such that the wafer-side marks have the same shape as the exposure openings in the corresponding mask member.

According to the invention, the shape of each of the concave portions in plan view differs between a plurality of wafer-side marks such that the wafer-side marks have the same shape as the exposure opening in the corresponding mask member. For this reason, during the resist pattern forming step, even when the exposure openings of a mask member different from a mask member prepared for one electrode film are aligned with the concave portions of the mask member, the shape of each of the exposure openings in plan view is not consistent with the shape of each of the concave portions in plan view, such that the entire concave portions cannot be exposed from the exposure opening. Therefore, it becomes possible to prevent a resist pattern from being formed in a state where different types of mask members are arranged, thereby suppressing the disuse or the like of a wafer and achieving low cost of a piezoelectric vibrating piece.

In the method of manufacturing a piezoelectric vibrating piece, the mask-side mark may have a pair of exposure openings at an interval in the mask member, each of the plurality of wafer-side marks may have a pair of concave portions at an interval in the wafer, and the shapes of the exposure openings in plan view may be asymmetrical in both directions of one direction in which a pair of exposure openings are distant from each other and another direction along the surface of the mask member and perpendicular to one direction.

In this case, the shapes of the exposure openings in plan view are asymmetrical in both directions of one direction and another direction. For this reason, during the resist pattern forming step, although the concave portions are exposed from the exposure opening in a state where the mask member is inversed in one direction with respect to a normal direction or is inversed in another direction, such that the entire concave portions cannot be exposed. Therefore, it is possible to prevent a resist pattern from being formed in a state where a mask member is arranged in a different direction.

In the method of manufacturing a piezoelectric vibrating piece, in the resist pattern forming step, a coating member may be arranged on the wafer, and a resist film may be applied while the concave portions of the wafer-side marks corresponding to the mask member prepared for one electrode film are covered with the coating member.

In this case, during the resist pattern forming step, the resist film is applied while the concave portions are covered with the coating member. Therefore, it is possible to suppress unclearness of the shape of the concave portion in plan view due to the application of the resist film, and to reliably align the mark portion with the concave portions.

According to another aspect of the invention, a piezoelectric vibrator includes a piezoelectric vibrating piece which is manufactured by the method of manufacturing a piezoelectric vibrating piece.

According to the invention, piezoelectric vibrator includes a piezoelectric vibrating piece which is manufactured by the method of manufacturing a piezoelectric vibrating piece, thereby achieving low cost.

Another aspect of the invention provides an oscillator in which the piezoelectric vibrator is electrically connected to an integrated circuit as an oscillating element.

Another aspect of the invention provides an electronic apparatus in which the piezoelectric vibrator is electrically connected to a timepiece unit.

Another aspect of the invention provides a radio-controlled timepiece in which the piezoelectric vibrator is electrically connected to a filter unit.

According to the invention, the oscillator, the electronic apparatus, and the radio-controlled timepiece of the invention include the piezoelectric vibrator, thereby manufacturing an oscillator, an electronic apparatus, and a radio-controlled timepiece at low cost.

According to the method of manufacturing a piezoelectric vibrating piece and the wafer of the invention, it is possible to prevent a resist pattern from being formed in a state where a mask member is erroneously arranged, thereby achieving low cost.

According to the piezoelectric vibrator, the oscillator, the electronic apparatus, and the radio-controlled timepiece of the invention, low cost can be achieved.

### BRIEF DESCRIPTION OF THE DRAWINGS

FIG. 1 is a diagram showing the content of a case of a piezoelectric vibrator according to an embodiment of the invention when the piezoelectric vibrating piece is viewed in plan view;

FIG. 2 is a plan view when the piezoelectric vibrating piece shown in FIG. 1 is viewed from above;

FIG. 3 is a plan view when the piezoelectric vibrating piece shown in FIG. 1 is viewed from below;

FIG. 4 is a perspective view of the piezoelectric vibrating piece shown in FIG. 1;

FIG. 5 is a sectional view taken along the line A-A of FIG. 2;

FIG. 6 is a sectional view taken along the line B-B of FIG. 1;

FIG. 7 is a sectional view taken along the line C-C of FIG. 2;

FIG. 8 is a plan view of an outline mask which constitutes an apparatus for manufacturing a piezoelectric vibrating piece, which is used for a method of manufacturing a piezoelectric vibrating piece according to the invention;

FIG. 9 is a plan view of a first mask which constitutes an apparatus for manufacturing a piezoelectric vibrating piece, which is used for a method of manufacturing a piezoelectric vibrating piece according to the invention;

FIG. 10 is a plan view of a second mask which constitutes an apparatus for manufacturing a piezoelectric vibrating piece, which is used for a method of manufacturing a piezoelectric vibrating piece according to the invention;

FIG. 11 is a flowchart of a method of manufacturing a piezoelectric vibrating piece according to the invention;

FIG. 12 is a process view showing a method of manufacturing a piezoelectric vibrating piece, and a sectional view corresponding to the line C-C of FIG. 2;

FIG. 13 is a process view showing a method of manufacturing a piezoelectric vibrating piece, and a plan view of a wafer;

FIG. 14 is a process view showing a method of manufacturing a piezoelectric vibrating piece, and a plan view of a wafer;

FIG. 15 is a process view showing a method of manufacturing a piezoelectric vibrating piece, and a sectional view corresponding to the line C-C of FIG. 2;

FIG. 16 is a process view showing a method of manufacturing a piezoelectric vibrating piece, and a plan view of a wafer;

FIG. 17 is a process view showing a method of manufacturing a piezoelectric vibrating piece, and a plan view of a wafer;

FIG. 18 is a diagram illustrating the action of a method of manufacturing a piezoelectric vibrating piece, and a plan view showing a state where, during a resist pattern forming step, a resist film is applied while through holes are not covered with a coating member;

FIG. 19 is a process view showing a method of manufacturing a piezoelectric vibrating piece, and a sectional view corresponding to the line C-C of FIG. 2;

FIG. 20 is a process view showing a method of manufacturing a piezoelectric vibrating piece, and a sectional view corresponding to the line C-C of FIG. 2;

FIG. 21 is a process view showing a method of manufacturing a piezoelectric vibrating piece, and a plan view of a wafer;

FIG. 22 is a process view showing a method of manufacturing a piezoelectric vibrating piece, and a sectional view corresponding to the line C-C of FIG. 2;

FIG. 23 is a process view showing a method of manufacturing a piezoelectric vibrating piece, and a plan view of a wafer;

FIG. 24 is a process view showing a method of manufacturing a piezoelectric vibrating piece, and a plan view of a wafer;

FIG. 25 is a process view showing a method of manufacturing a piezoelectric vibrating piece, and a sectional view corresponding to the line C-C of FIG. 2;

FIG. 26 is a process view showing a method of manufacturing a piezoelectric vibrating piece, and a sectional view corresponding to the line C-C of FIG. 2;

FIG. 27 is a process view showing a method of manufacturing a piezoelectric vibrating piece, and a plan view of a wafer;

FIG. 28 is a diagram illustrating the action of a method of manufacturing a piezoelectric vibrating piece, and a plan view when a first mask is inversed;

FIG. 29 is a configuration diagram showing an oscillator according to an embodiment of the invention;

FIG. 30 is a configuration diagram showing an electronic apparatus according to an embodiment of the invention;

FIG. 31 is a configuration diagram showing a radio-controlled timepiece according to an embodiment of the invention;

FIG. 32 is a plan view showing a modification of exposure openings and through holes which are used for a method of manufacturing a piezoelectric vibrating piece according to the invention;

FIG. 33 is a plan view showing a modification of exposure openings and through holes which are used for a method of manufacturing a piezoelectric vibrating piece according to the invention; and

FIG. 34 is a plan view showing a modification of exposure openings and through holes which are used for a method of manufacturing a piezoelectric vibrating piece according to the invention.

### DETAILED DESCRIPTION OF THE PREFERRED EMBODIMENTS

Hereinafter, an embodiment of the invention will be described with reference to the drawings.

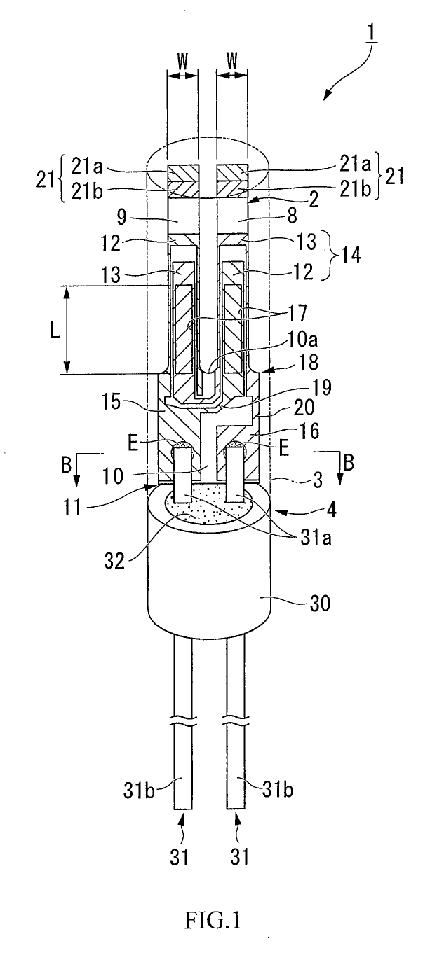

As shown in FIG. 1, a piezoelectric vibrator 1 is a cylinder package type piezoelectric vibrator, and includes a tuning fork type piezoelectric vibrating piece 2, a plug 4 in which the piezoelectric vibrating piece 2 is mounted, and a case 3 which seals the piezoelectric vibrating piece 2 airtight along with the plug 4.

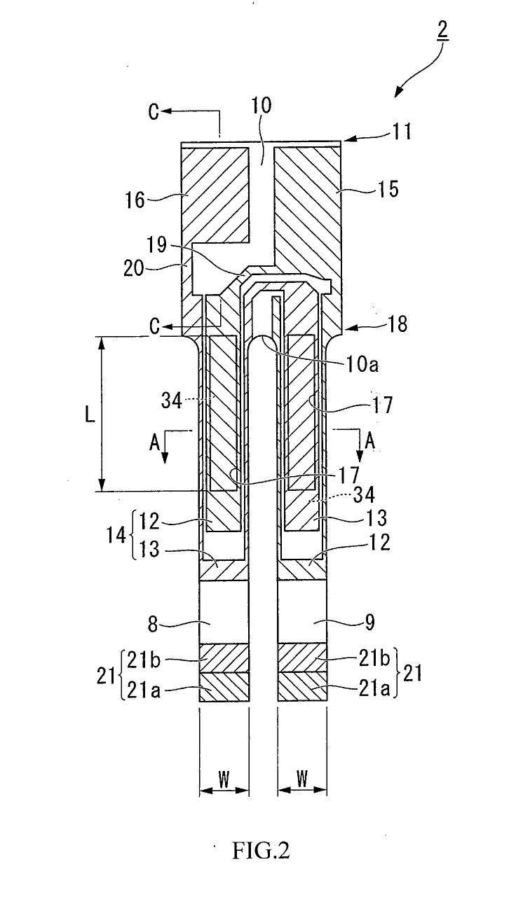

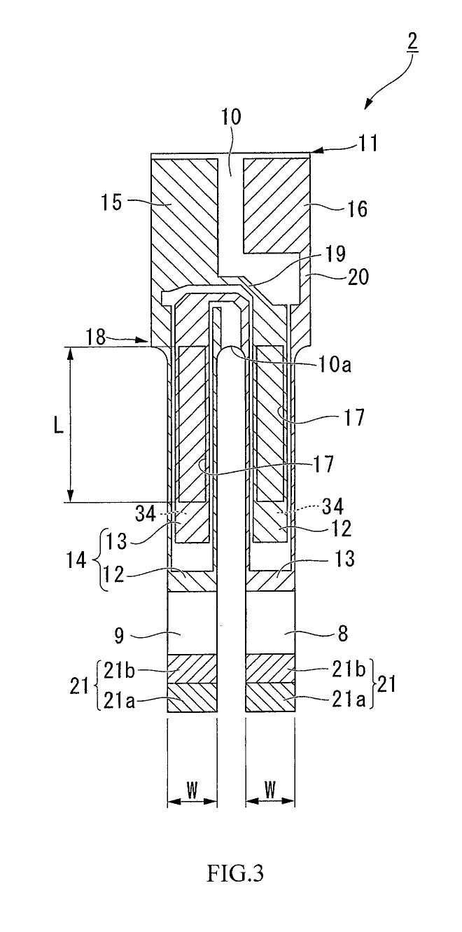

As shown in FIGS. 2 and 3, the piezoelectric vibrating piece 2 is a tuning fork type vibrating piece which is formed of a piezoelectric material, such as crystal, lithium tantalate, or lithium niobate, and vibrates when a predetermined voltage is applied.

The piezoelectric vibrating piece 2 includes a piezoelectric plate 11 which has a pair of vibrating arm portions 8 and 9 arranged in parallel with each other and a base portion 10 fixing the base ends of a pair of vibrating arm portions 8 and 9 as a single body, an excitation electrode 14 which has a first excitation electrode 12 and the second excitation electrode 13 formed on the outer surfaces of a pair of vibrating arm portions 8 and 9 to vibrate a pair of vibrating arm portions 8 and 9, and mount electrodes 15 and 16 which are electrically connected to the first excitation electrode 12 and the second excitation electrode 13.

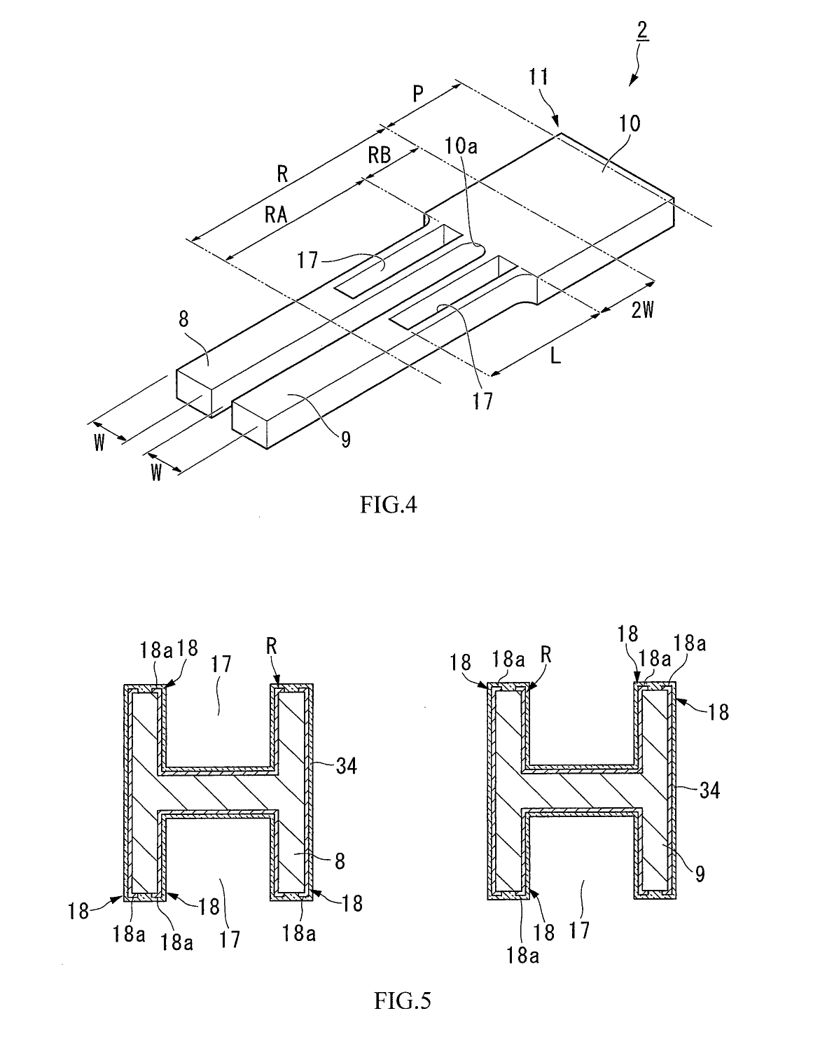

The piezoelectric vibrating piece 2 of this embodiment also includes groove portion 17 which are formed on both principal surfaces of a pair of vibrating arm portions 8 and 9 at a length L from the base end portions of the vibrating arm portions 8 and 9 toward the front end portions. As shown in FIG. 4, the groove portions 17 are formed from the base end portions of the vibrating arm portions 8 and 9 to substantially near the middle. The widths of a pair of vibrating arm portions 8 and 9 are W in common. A portion of the base portion 10 which is connected to the base end portions of a pair of vibrating arm portions 8 and 9 is referred to as a crotch portion 10a.

As shown in FIGS. 2, 3, and 5, the excitation electrode 14 having the first excitation electrode 12 and the second excitation electrode 13 is an electrode which vibrates a pair of vibrating arm portions 8 and 9 at a predetermined resonance frequency in a direction close to each other or distant from each other. The first excitation electrode 12 and the second excitation electrode 13 are patterned on the outer surfaces of a pair of vibrating arm portions 8 and 9 in a state of being electrically separated from each other. Specifically, the first excitation electrode 12 is mainly formed the groove portion 17 of the vibrating arm portion 8 and on both lateral surfaces of the vibrating arm portion 9, and the second excitation electrode 13 is mainly formed on both lateral surfaces of the vibrating arm portion 8 and on the groove portion 17 of the vibrating arm portion 9.

As shown in FIGS. 2 and 3, the first excitation electrode 12 and the second excitation electrode 13 are continuously formed on both principal surfaces of the base portion 10, and are respectively connected to the mount electrodes 15 and 16 through extraction electrodes 19 and 20. The mount electrodes 15 and 16 are formed at the base end of the piezoelectric plate 11. That is, the excitation electrode 14, the mount electrodes 15 and 16, and the extraction electrodes 19 and 20 function as an electrode portion (laminate) 18 which vibrates a pair of vibrating arm portions 8 and 9 when a predetermined voltage is applied.

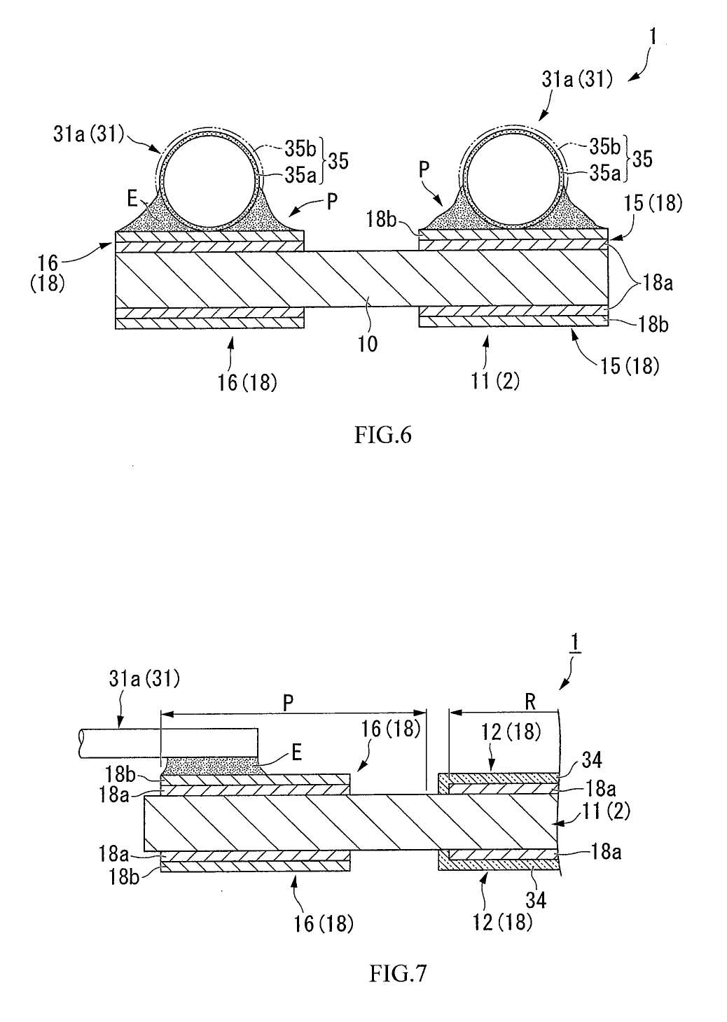

As shown in FIGS. 6 and 7, the electrode portion 18 has a base metal layer (electrode film) 18a made of chromium (Cr) and a finish metal layer (electrode film) 18b made of gold (Au) sequentially laminated on the outer surface of the piezoelectric plate 11. The metal layers 18a and 18b have different patterns.

The base metal layer 18a is provided to improve adhesiveness between the finish metal layer 18b and the piezoelectric vibrating piece 2.

With regard to the finish metal layer 18b, as shown in FIGS. 4, 5, and 7, a part of or the entire part of the finish metal layer 18b is removed in a region from the base end portions to the front end portions in the vibrating arm portions 8 and 9. Specifically, on the front end portion side with respect to the base end portion of each of the vibrating arm portions 8 and 9, the entire part of the finish metal layer 18b is removed to a position at equal to or greater a length L from the base end portion (a region RA shown in FIG. 4). On the base portion 10 side with respect to the base end portion of each of the vibrating arm portions 8 and 9, the entire part of the finish metal layer 18b is removed to a position at a distance twice the width W of each of the vibrating arm portions 8 and 9 from the base end portion toward the base portion 10 (a region RB shown in FIG. 4).

That is, the electrode portion 18 is formed of the base metal layer 18a over the region RA and the region RB, where the groove portions 17 of the vibrating arm portions 8 and 9 are formed, including the inside of the groove portions 17. In the region RA and the region RB, an insulating film 34 made of silicon oxide (SiO₂) or the like is coated to cover the base metal layer 18a. Thus, even when conductive particles are stuck between the excitation electrodes 12 and 13 of the vibrating arm portions 8 and 9, it is possible to prevent short-circuit between the electrodes.

In this embodiment, a single-layered region R which is the total region of the region RA and the region RB is a region where the excitation electrodes 12 and 13 are formed. In the single-layered region R, an insulating film 34 is formed on the base metal layer 18a in a state where the finish metal layer 18b is removed, thereby improving adhesiveness of the insulating film 34 and reliably preventing short-circuit of the excitation electrodes 12 and 13.

As described above, with regard to the extraction electrodes 19 and 20 and the mount electrodes 15 and 16 which are formed on the base end side with respect to the single-layered region R in the piezoelectric plate 11, the base metal layer 18a and the finish metal layer 18b are laminated. Hereinafter, a region where the base metal layer 18a and the finish metal layer 18b is referred to as a laminated region P.

At the front end of each of a pair of vibrating arm portions 8 and 9, a weight metal film 21 is formed to perform adjustment (frequency adjustment) such that the vibration state of the vibrating arm portion is within a predetermined frequency range. The weight metal film 21 is divided into a rough adjustment film 21a which is used to roughly adjust frequency and a fine adjustment film 21b which is used to finely adjust frequency. With frequency adjustment using the rough adjustment film 21a and the fine adjustment film 21b, it is possible to make the frequency of each of a pair of vibrating arm portions 8 and 9 be in the nominal frequency range of a device.

As shown in FIG. 1, the case 3 is formed in the shape of a bottomed cylinder, is press-fit to the outer circumference of a stem 30 (described below) of the plug 4 in a state where the piezoelectric vibrating piece 2 is accommodated therein, and is fixedly engaged. Press-fitting of the case 3 is done in a vacuum atmosphere, and a space which surrounds the piezoelectric vibrating piece 2 in the case 3 is maintained under vacuum.

The plug 4 has a stem 30 which hermetically seals the case 3, two lead terminals 31 which are arranged in parallel with each other to pass through the stem 30, and an insulating filling material 32 which is filled inside the stem 30 to fix the stem 30 and the lead terminals 31.

The stem 30 is formed of a metal material in an annular shape. The filling material 32 is made of, for example, borosilicate glass. The surfaces of the lead terminals 31 and the outer circumference of the stem 30 are coated with plating 35 (described below) made of the same material.

With regard to the two lead terminals 31, a portion which protrudes inward of the case 3 becomes an inner lead 31a, and a portion which protrudes outward of the case 3 becomes an outer lead 31b. The lead terminals 31 has a diameter of, for example, about 0.12 mm, and as the base material of the lead terminals 31, kovar (FeNiCo alloy) is commonly used. As shown in FIG. 6, the outer surfaces of the lead terminals 31 and the outer circumference of the stem 30 are coated with the plating 35. As the material for the plating to be coated, copper (Cu) plating or the like is used as a base film 35a, and solder plating (alloy of tin and lead having a weight ratio of 1:9) having a high melting point of, for example, 300 degrees, is used as a finish film 35b.

Cold pressure welding is carried out under vacuum on the inner circumference of the case 3 while interposing the plating 35 coated on the outer circumference of the stem 30, such that the inside of the case 3 is sealed airtight in a vacuum state.

As shown in FIG. 7, the inner leads 31a and the mount electrodes 15 and 16 are mounted on the finish metal layer 18b through joints E formed by melting the finish film (high-melting-point solder plating) 35b. That is, the inner leads 31a and the mount electrodes 15 and 16 are mechanically bonded to each other and electrically connected to each other through the joints E. As a result, the piezoelectric vibrating piece 2 is mounted on the two lead terminals 31.

The above-described two lead terminals 31 function as external connection terminals which have one end (outer lead 31b) electrically connected to the outside and the other end (inner lead 31a) mounted with the piezoelectric vibrating piece 2.

When the piezoelectric vibrator 1 configured as above is activated, a predetermined driving voltage is applied to the outer leads 31b of the two lead terminals 31. Thus, a current can flow in the excitation electrode 14 having the first excitation electrode 12 and the second excitation electrode 13 through the inner leads 31a, the joints E, the mount electrodes 15 and 16, and the extraction electrodes 19 and 20, thereby vibrating a pair of vibrating arm portions 8 and 9 at a predetermined frequency in a direction close to each other or distant from each other. With the use of the vibration of a pair of vibrating arm portions 8 and 9, the piezoelectric vibrator can be used as a time source, a timing source of a control signal, a reference signal source, or the like.

### (Method of Manufacturing Piezoelectric Vibrating Piece)

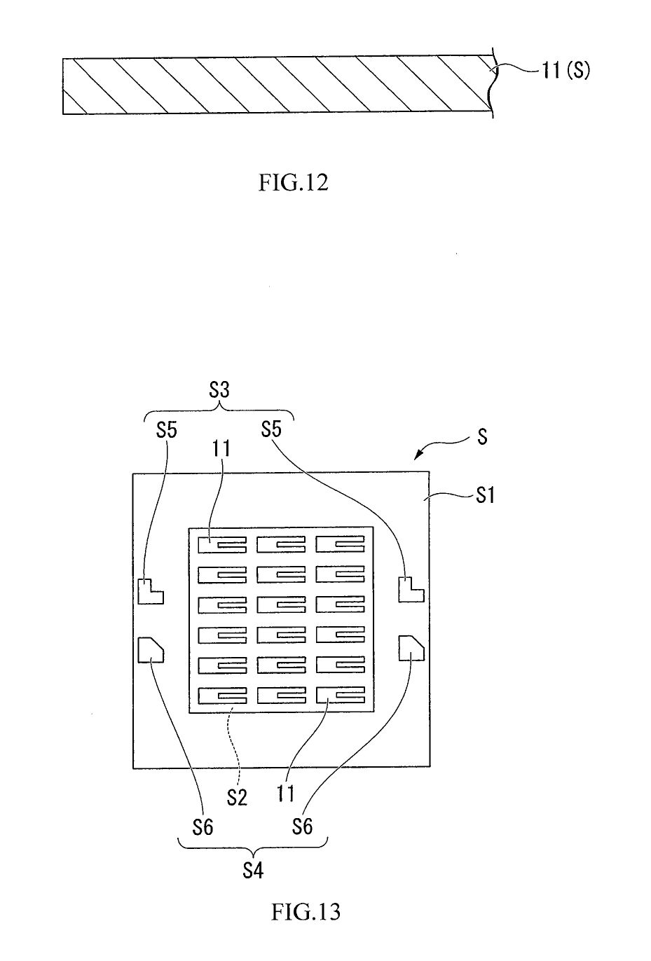

Next, description will be provided as to a method which forms the above-described piezoelectric vibrating piece 2 using a wafer S (see FIG. 12) made of a piezoelectric material.

Initially, an apparatus 40 for manufacturing a piezoelectric vibrating piece which is used in this manufacturing method will be described.

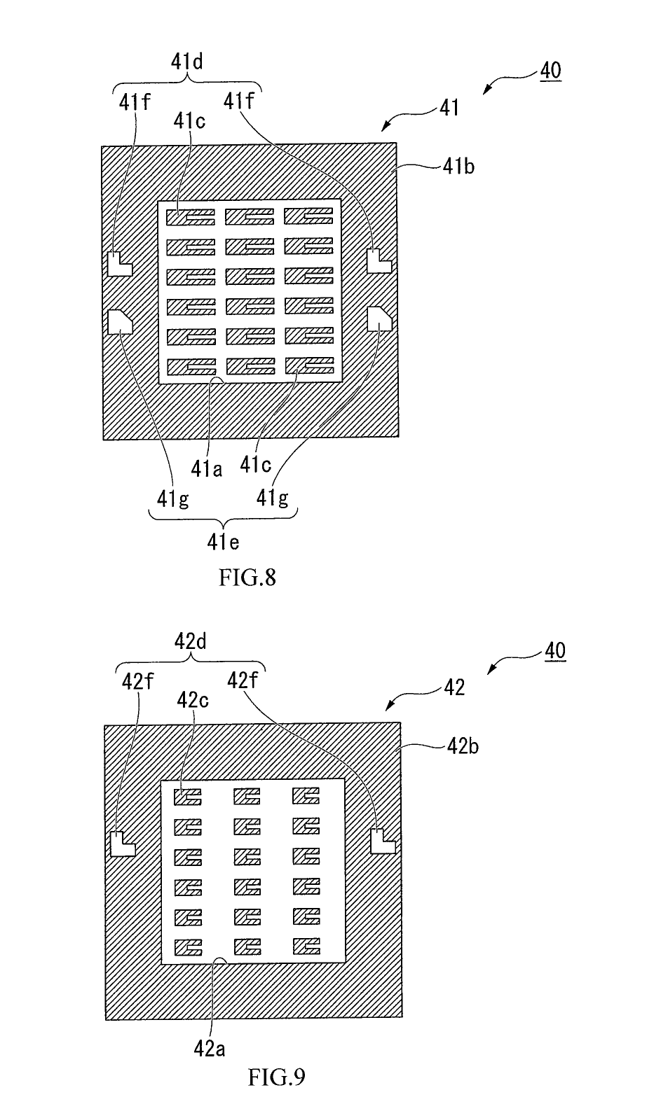

As shown in FIGS. 8 to 10, the manufacturing apparatus 40 includes an outline mask 41 which forms the outline shape of the piezoelectric plate 11 in a wafer, and two (multiple) electrode film masks (mask member) 42 and 43 which are respectively prepared for the base metal layer 18a and the finish metal layer 18b.

The masks 41, 42, and 43 respectively include frame portions 41b, 42b, and 43b which define exposure regions 41a, 42a, and 43a, and a plurality of coated portions 41c, 42c, and 43c which are arranged in the exposure regions 41a, 42a, and 43a and connected to the frame portions 41b, 42b, and 43b through connection portions (not shown).

The outline shapes of the frame portions 41b, 42b, and 43b of the masks 41, 42, and 43 and the exposure regions 41a, 42a, and 43a are all a rectangle in plan view, and in the example of the drawing, a square in plan view. The frame portions 41b, 42b, and 43b and the exposure regions 41a, 42a, and 43a are arranged coaxially with the axes of the masks 41, 42, and 43.

The coated portion 41c of the outline mask 41 is formed to follow the outline shape of the piezoelectric plate 11. The coated portion 42c of the first mask 42 prepared for the base metal layer 18a from among the two electrode film masks 42 and 43 is formed to follow the outline shape of the base metal layer 18a. The coated portion 43c of the first mask 43 for the finish metal layer 18b is formed to follow the outline shape of the finish metal layer 18b.

In the masks 41, 42, and 43 shown in FIGS. 8 to 10, for ease of understanding, the shape of each of the coated portions 41c, 42c, and 43c is simplified, and the number of coated portions 41c, 42c, and 43c is omitted.

As shown in FIG. 8, in the frame portion 41b of the outline mask 41, two marks forming portions 41d and 41e are formed to form two wafer-side marks S3 and S4 (see FIG. 13) corresponding to the two electrode film masks 42 and 43 in the wafer S. The mark forming portions 41d and 41e respectively have a pair of mark openings 41f and 41g which pass through the frame portion 41b.

A pair of mark openings 41f and 41g are arranged at an interval, and in the example of the drawing, are respectively arranged in the opposing portions of the frame portion 41b with the axis of the outline mask 41 interposed therebetween. In this embodiment, one direction in which a pair of mark openings 41f and 41g are distant from each other is in parallel with one side of the frame portion 41b.

A pair of mark openings 41f of one of the two mark forming portions 41d and 41e are arranged to be shifted with respect to another mark openings 41g in another direction along the surface of the outline mask 41 and perpendicular to one direction.

The shape of each of the mark openings 41f and 41g in plan view differs between the two mark forming portions 41d and 41e.

The shapes in plan view of the mark openings 41f in the first mark forming portion 41d from the two mark forming portions 41d and 41e are asymmetrical in both directions of one direction and another direction. In the example of the drawing, the shape of each of the mark openings 41f is an L shape in which linear portions extending in one direction and another direction are connected to each other. The shapes in plan view of the mark openings 41g in the second mark forming portion 41e from the two mark forming portions 41d and 41e are pentagonal asymmetrical in both directions of one direction and another direction. In the example of the drawing, the shape of each of the mark openings 41g in plan view is a shape in which one corner portion of a square (rectangle) extending in both directions of one direction and another direction is chamfered.

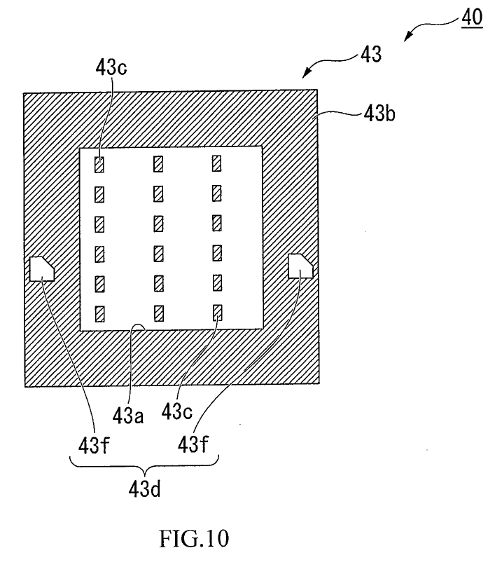

As shown in FIGS. 9 and 10, mask-side marks 42d and 43d are respectively formed in the frame portions 42b and 43b of the two electrode film masks 42 and 43. In this embodiment, the mask-side marks 42d and 43d respectively have pairs of exposure openings 42f and 43f which are formed at an interval in the electrode film masks 42 and 43 to pass through the electrode film masks 42 and 43.

The mask-side marks 42d and 43d differ between the two electrode film masks 42 and 43. In this embodiment, the shape of each of the exposure openings 42f and 43f in plan view differs between the two electrode film masks 42 and 43.

As shown in FIG. 9, the mask-side mark 42d formed in the first mask 42 corresponds to the first mark forming portion 41d formed in the outline mask 41. The shape of each of the exposure openings 42f in plan view in the mask-side mark 42d of the first mask 42 is the same as the shape of each of the mark openings 41f in the first mark forming portion 41d in plan view. In this embodiment, the shapes of the exposure openings 42f in plan view are asymmetrical in both directions of one direction in which a pair of exposure openings 42f are distant from each other and another direction along the surface of the first mask 42 and perpendicular to one direction. The shape of each of the exposure openings 42f in plan view is an L shape in which linear portions extending in one direction and another direction are connected to each other.

The interval between the exposure openings 42f of the first mask 42 is the same as the interval between the mark openings 41f in the first mark forming portion 41d.

As shown in FIG. 10, the mask-side mark 43d formed in the second mask 43 corresponds to the second mark forming portion 41e. The shape of each of the exposure openings 43f in the mask-side mark 43d of the second mask 43 in plan view is the same as the shape of each of the mark openings 41g in the second mark forming portion 41e. In this embodiment, the shapes of the exposure openings 43f in plan view are pentagonal asymmetrical in both directions of one direction in which a pair of exposure openings 43f are distant from each other and another direction along the surface of the second mask 43 and perpendicular to one direction. In the example of the drawing, the shape of each of the exposure openings 43f in plan view is a shape in which one corner portion of a square (rectangle) extending in both directions of one direction and another direction is chamfered.

The interval between the exposure openings 43f of the second mask 43 is the same as the interval between the mark openings 41g in the second mark forming portion 41e.

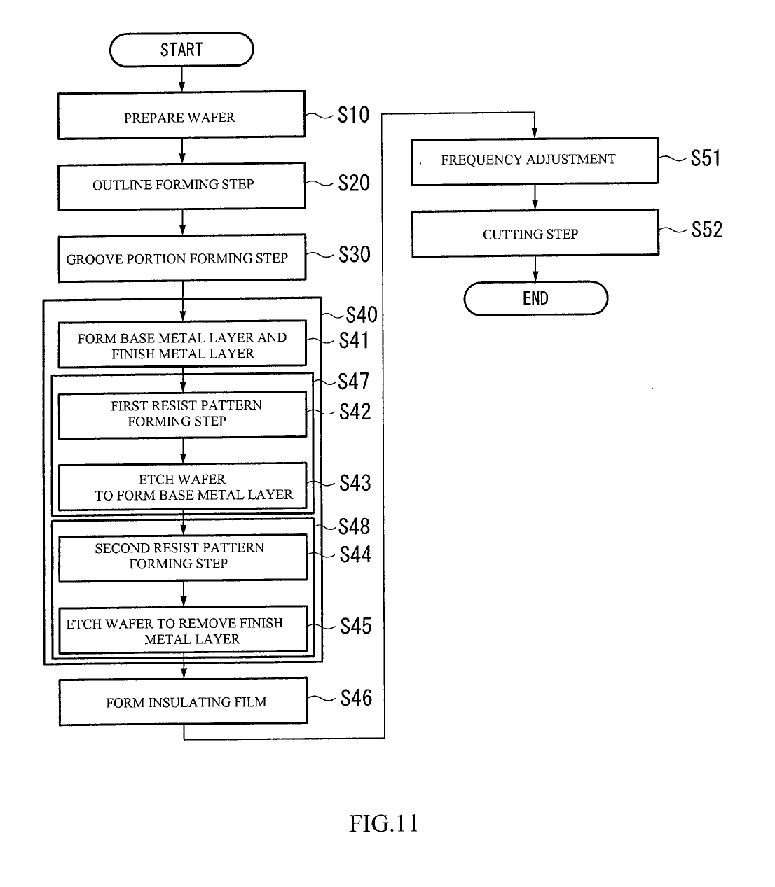

Next, a method of manufacturing a piezoelectric vibrating piece which forms the piezoelectric vibrating piece 2 using the apparatus 40 for manufacturing a piezoelectric vibrating piece will be described with reference to FIG. 11.

First, as shown in FIG. 12, a Lambert raw stone of crystal is sliced at a predetermined angle to form a wafer S having a constant thickness. Subsequently, the wafer S is wrapped and subjected to rough processing. Thereafter, the affected layer is removed by etching, and mirror grinding processing, such as polishing, is performed to form the wafer S having a predetermined thickness (S10).

Next, an outline forming step of forming the outline shapes of a plurality of piezoelectric plates 11 in the wafer S after polishing is performed (S20).

At this time, first, a protective film in which, for example, a chromium layer, a gold layer, and the like are laminated is laminated on both surfaces of the wafer S by, for example, sputtering or the like. Thereafter, a positive type resist film (not shown) is applied onto both surfaces of the wafer S from above the protective film, and the outline mask 41 is arranged above the resist film.

Light is irradiated onto the resist film through the outline mask 41, and a resist pattern is exposed to the resist film. After the outline mask 41 is detached, the resist film is developed to remove an exposed portion. Thereafter, metal etching is performed to remove the protective film exposed from the exposed portion. At the same time the resist film is removed, crystal etching is performed to etch the wafer S exposed from the removed portion of the protective film. Thereafter, the protective film is removed, and the outline forming step ends.

The outline forming step is performed, such that, as shown in FIG. 13, the outline shapes of the piezoelectric plates 11 are formed in the wafer S. The shape of the wafer S in plan view is a rectangle, and in the example of the drawing, a square, and the outline shape of the piezoelectric plate 11 is formed within a plate forming region S2 inward of the outer circumferential portion S1 of the wafer S. A plate forming region S2 is a portion exposed from the exposure region 41a of the outline mask 41. In the plate forming region S2, the outline shape of the piezoelectric plate 11 and a portion excluding a connection portion (not shown) which connects the outline shape and the outer circumferential portion S1 are removed by the crystal etching.

In this embodiment, since the mark forming portions 41d and 41e are formed in the outline mask 41, during the outline forming step, the two wafer-side marks S3 and S4 corresponding to the two electrode film masks 42 and 43 are formed in the wafer S simultaneously with the outline shape of the piezoelectric plate 11.

During the outline forming step, when the outline mask 41 is arranged above the resist film, the two wafer-side marks S3 and S4 are formed in the portions exposed from the mark forming portions 41d and 41e. The wafer-side marks S3 and S4 respectively have a pair of through holes (concave portions) S5 and S6 formed at an interval in the wafer S.

A pair of through holes S5 and S6 are respectively arranged in the opposing portions of the outer circumferential portion S1 of the wafer S with the axis of the wafer S interposed therebetween. In this embodiment, one direction in which a pair of through holes S5 and S6 are distant from each other is in parallel with one side of the outer circumferential portion S1.

A pair of through holes S5 of one of the two wafer-side marks S3 and S4 are arranged to be shifted with respect to another pair of through holes S6 in another direction along the surface of the wafer S and perpendicular to one direction.

The shapes of the through holes S5 and S6 in plan view differ between the two wafer-side marks S3 and S4 such that the wafer-side marks S3 and S4 have the same shape as the exposure openings 42f and 43f in the electrode film masks 42 and 43 in plan view.

In this embodiment, the shape in plan view of each of the through holes S5 of the first wafer-side mark S3 corresponding to the first mask 42 from the two wafer-side marks S3 and S4 are the same as the shapes of the exposure openings 42f of the first mask 42 in plan view. The shapes of the through holes S5 in plan view are asymmetrical in both directions of one direction and another direction. In the example of the drawing, the shape of each of the through holes S5 in plan view is an L shape in which linear portions extending in one direction and another direction are connected to each other.

The interval between the through holes S5 of the first wafer-side mark S3 is the same as the interval between the exposure openings 42f of the first mask 42.

The shape in plan view of each of the through holes S6 of the second wafer-side mark S4 corresponding to the second mask 43 from the two wafer-side marks S3 and S4 is the same as the shape of each of the exposure openings 43f of the second mask 43 in plan view. The shapes of the through holes S6 in plan view are pentagonal asymmetrical in both directions of one direction and another direction. In the example of the drawing, the shape of each of the through holes S6 in plan view is a shape in which one corner portion of a square (rectangle) extending in both directions of one direction and another direction is chamfered.

The interval between the through holes S6 of the second wafer-side mark S4 is the same as the interval between the exposure openings 43f of the second mask 43.

At the same time the outline forming step is performed, a groove portion forming step of forming the groove portions 17 in a pair of vibrating arm portions 8 and 9 is performed (S30), and thereafter, an electrode forming step of forming the electrode portion 18 in the wafer S in which the outline shape of the piezoelectric plate 11 is formed is performed (S40). During this step, the electrode portion 18 (the excitation electrodes 14, the extraction electrodes 19 and 20, and the mount electrodes 15 and 16) and the weight metal films 21 are formed.

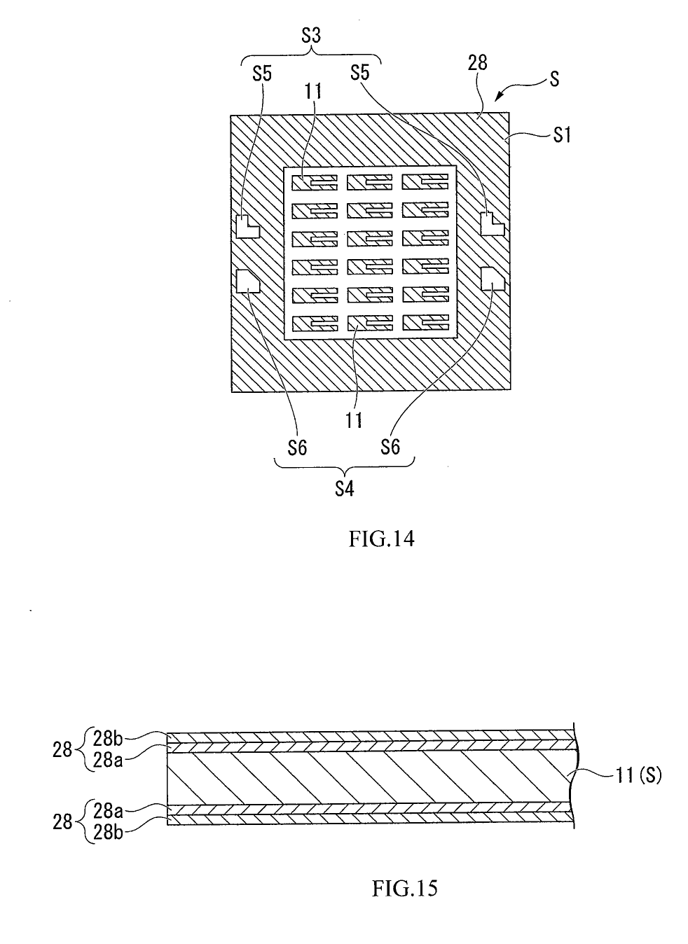

Initially, as shown in FIGS. 14 and 15, a first metal film 28a serving as the base metal layer 18a and a second metal film 28b serving as the finish metal layer 18b are formed sequentially on the piezoelectric plate 11 by evaporation, sputtering, or the like to form a metal laminated film 28 (S41).

When the wafer S is formed of, for example, crystal and is transparent, it is difficult to confirm the shapes of the through holes S5 and S6. Thus, as in this embodiment, if a metal film, such as the first metal film 28a or the second metal film 28b, is formed on the surface of the wafer S, it becomes easy to confirm the shapes of the through holes S5 and S6.

Next, a first electrode film forming step of forming the base metal layer 18a in the wafer S by a photolithography technique is performed using the first mask 42 (S47).

In the first electrode film forming step, first, a resist film 50 is applied to the wafer S, and the first mask 42 is arranged. Thereafter, a first resist pattern forming step of irradiating light through the first mask 42 to form a first resist pattern is performed (S42).

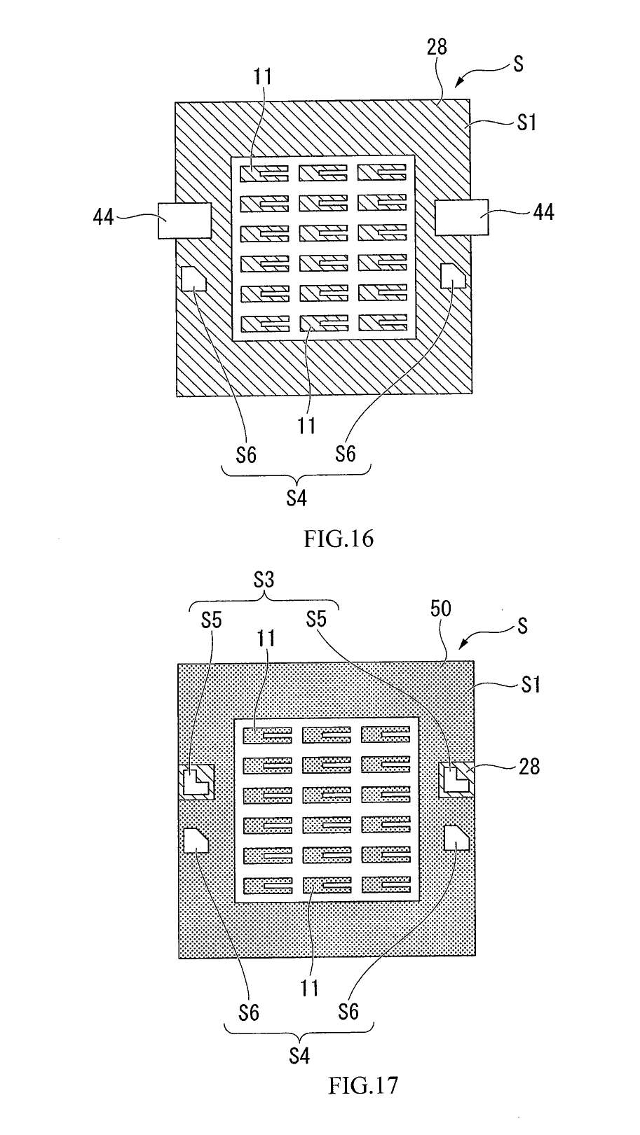

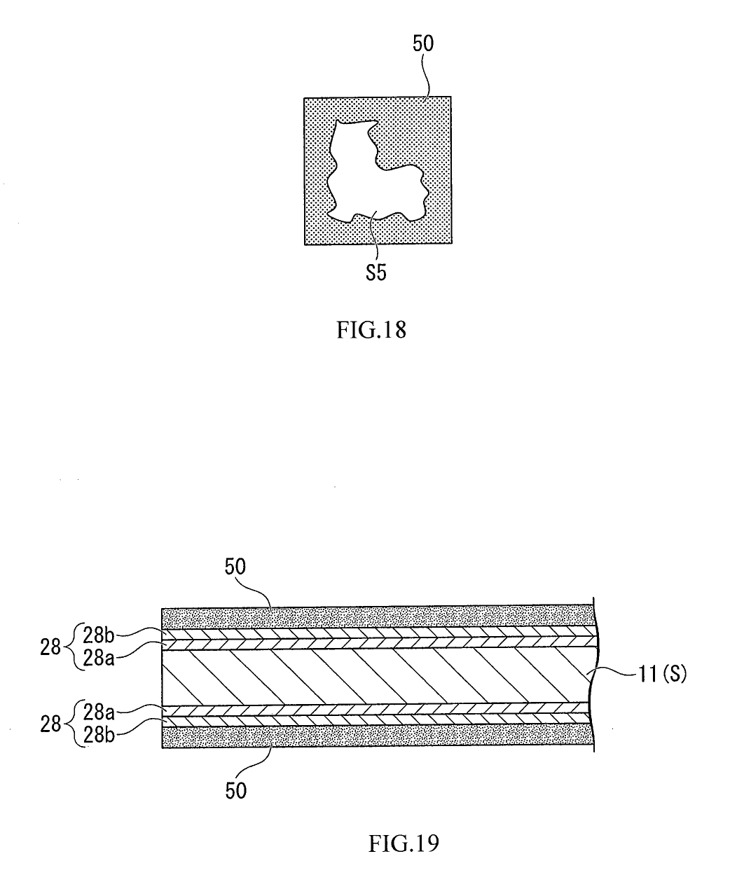

At this time, first, as shown in FIG. 16, a coating member 44 is arranged on the wafer S, and the resist film 50 is applied while the through holes S5 of the first wafer-side mark S3 are covered with the coating member 44. Thus, as shown in FIG. 17, the resist film 50 is applied to a portion excluding the through holes S5 and the peripheral portions of the through holes S5, and as shown in FIG. 18, the resist film 50 is applied, thereby suppressing unclearness of the shapes of the through holes S5.

In this way, after the wafer S shown in FIG. 19 is formed in which the metal laminated film 28 and the resist film 50 are laminated, the first mask 42 is arranged on the wafer S. At this time, the first mask 42 is arranged on the wafer S such that the mask-side mark 42d formed in the first mask 42 is aligned with the first wafer-side mark S3, and the through holes S5 are exposed from the exposure openings 42f. Since the shapes of the through holes S5 in plan view are the same as the shapes of the exposure openings 42f in plan view, at this time, the entire part of the through holes S5 are exposed from the exposure openings 42f.

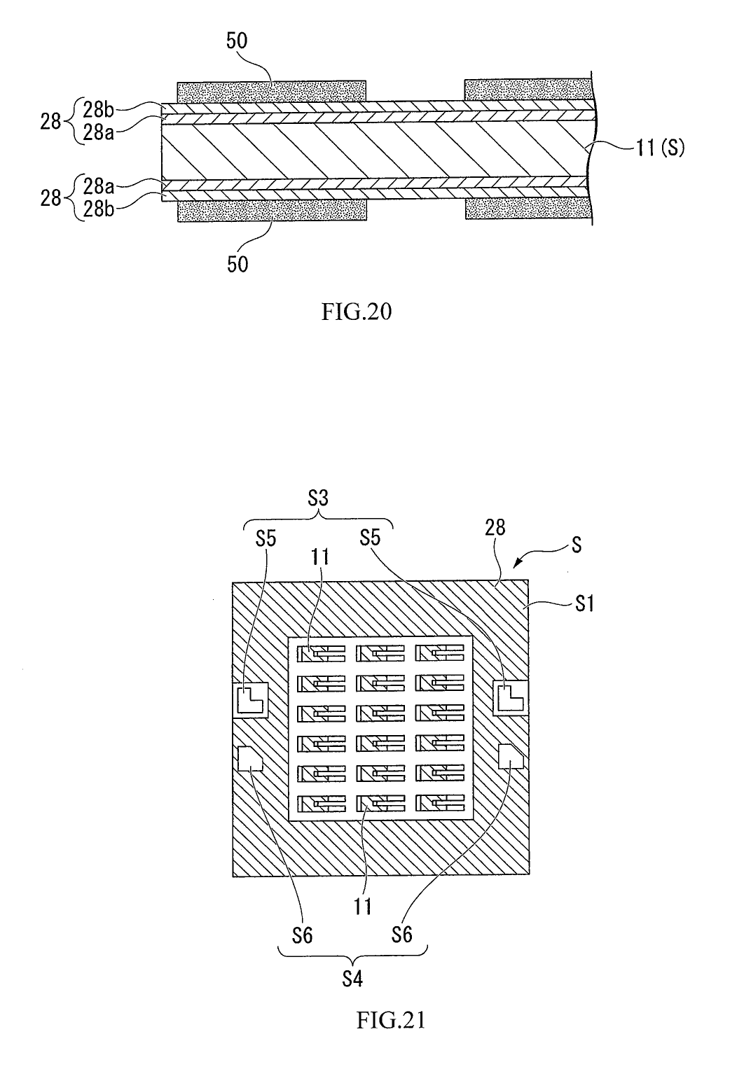

In this embodiment, when the first mask 42 is arranged on the wafer S such that the mask-side mark 42d is aligned with the first wafer-side mark S3, the coated portion 42c of the first mask 42 is configured to cover the regions where the mount electrodes 15 and 16, the excitation electrodes 12 and 13, the extraction electrodes 19 and 20, and the weight metal films 21 are formed. After light is irradiated through the first mask 42, if the first mask 42 is detached and the resist film 50 is developed, as shown in FIG. 20, a resist pattern which covers a portion where the metal laminated film 28 will remains, that is, the forming regions is formed.

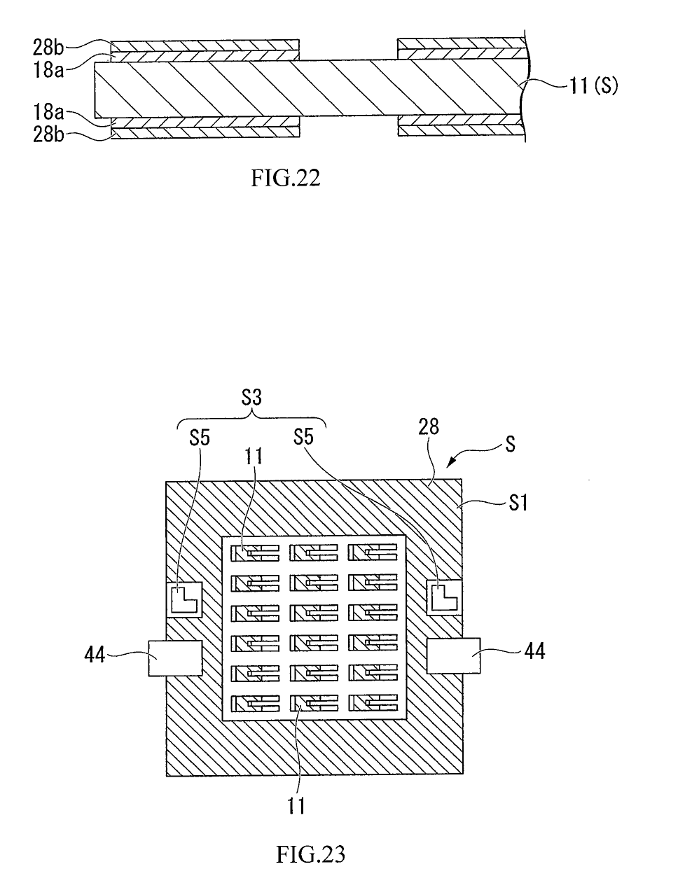

An etching step of etching the first metal film 28a and the second metal film 28b with the remaining resist film 50 as a mask is performed (S43), and thereafter, the resist film 50 is removed. With this etching step, as shown in FIGS. 21 and 22, the first metal film 28a becomes the base metal layer 18a from the two metal films which constitute the electrode portion 18.

Next, a second electrode film forming step of forming the finish metal layer 18b in the wafer S by a photolithography technique is performed using the second mask 43 (S48). The second electrode film forming step is performed by removing the second metal film 28b which is present in the single-layered region R (see FIG. 4).

During the second electrode film forming step, first, the resist film 50 is applied onto the wafer S, and the second mask 43 is arranged. Thereafter, a second resist pattern forming step of irradiating light through the second mask 43 to form a second resist pattern is performed (S44).

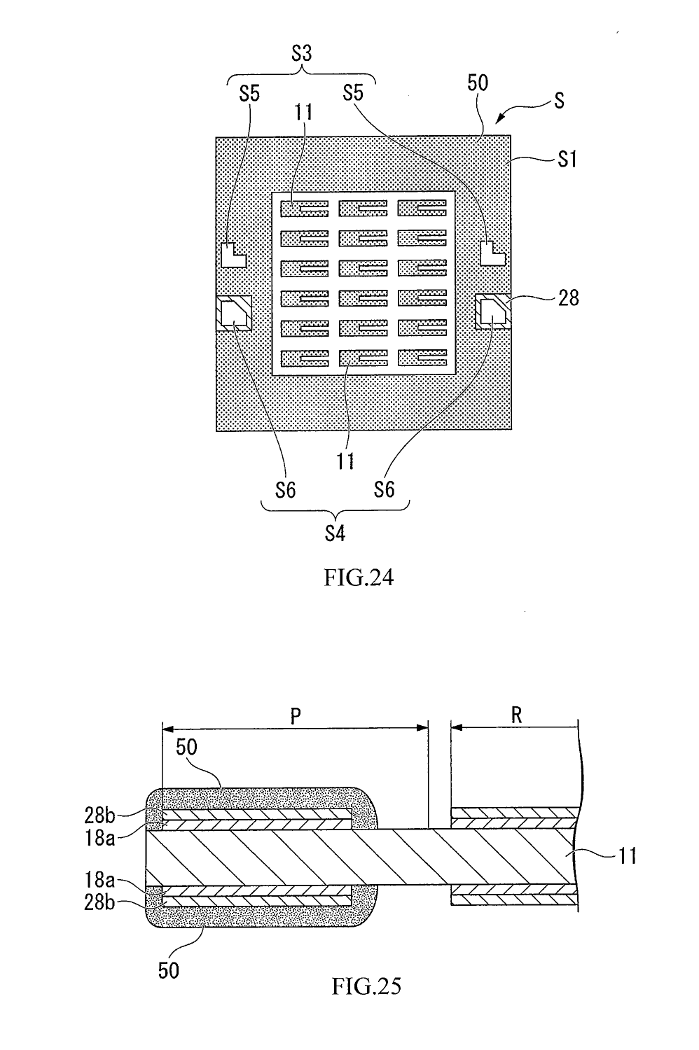

At this time, first, as shown in FIG. 23, the coating member 44 is arranged on the wafer S, and the resist film 50 is applied while the through holes S6 of the second wafer-side mark S4 are covered with the coating member 44. Thus, as shown in FIG. 24, the resist film 50 is applied to a portion excluding the through holes S6 and the peripheral portions of the through holes S6.

Thereafter, the second mask 43 is arranged on the wafer S such that the mask-side mark 43d formed in the second mask 43 is aligned with the second wafer-side mark S4, and the through holes S6 are exposed from the exposure openings 43f.

In this embodiment, when the second mask 43 is arranged on the wafer S such that the mask-side mark 43d is aligned with the second wafer-side mark S4, the coated portion 43c of the second mask 43 is configured to cover the laminated region P. Thus, after light is irradiated through the second mask 43, if the second mask 43 is detached and the resist film 50 is developed, as shown in FIG. 25, a resist pattern which covers a portion where the second metal film 28b will remains, that is, the laminated region P is formed.

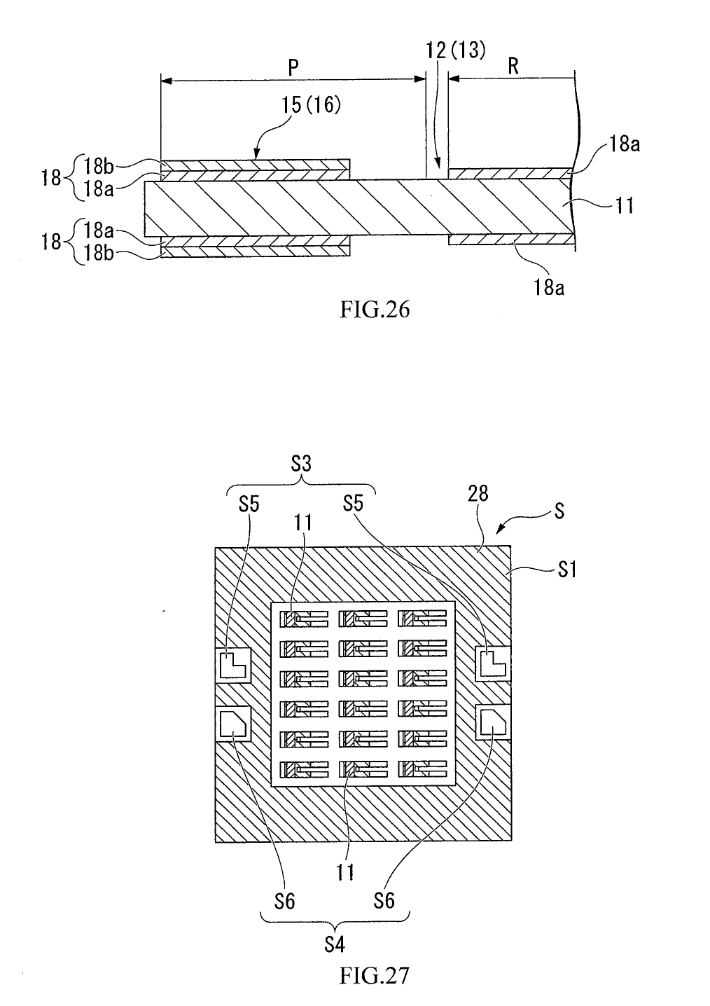

An etching step of removing the second metal film 28b through etching with the remaining resist film 50 as a mask is performed (S45), and thereafter, the resist film 50 is removed. With this etching step, as shown in FIGS. 26 and 27, the second metal film 28b becomes the finish metal layer 18b from the two metal layers which constitute the electrode portion 18, and the electrode portion 18 and the weight metal films 21 are formed. Thus, the electrode forming step ends.

Thereafter, in the single-layered region R with the finish metal layer 18b removed, the insulating film 34 made of an inorganic insulating material, such as SiO2, is formed on the base metal layer 18a through a metal mask (not shown) or the like by a CVD method or the like (S46). When this happens, the insulating film 34 is formed to cover the base metal layer 18a of the single-layered region R.

Thereafter, a rough adjustment step of roughly adjusting resonance frequency with respect to the entire part of the vibrating arm portions 8 and 9 formed in the wafer S is performed. This is, for example, a step of irradiating laser light onto the rough adjustment films 21a of the weight metal films 21 to reduce a weight applied to the front ends of a pair of vibrating arm portions 8 and 9, thereby roughly adjusting frequency (S51).

Next, a cutting step of cutting connection portions which connect the wafer S and the piezoelectric vibrating pieces 2 and chipping a plurality of piezoelectric vibrating pieces 2 from the wafer S is performed (S52). Thus, a plurality of piezoelectric vibrating pieces 2 in which the electrode portion 18 (the excitation electrodes 14, the extraction electrodes 19 and 20, and the mount electrodes 15 and 16) and the weight metal films 21 are formed can be manufactured from the wafer S at one time.

As described above, according to the method of manufacturing a piezoelectric vibrating piece and the wafer of this embodiment, the shapes of the through holes S5 and S6 differ between a plurality of wafer-side marks S3 and S4 such that the wafer-side marks S3 and S4 have the same shape as the shapes in plan view of the exposure openings 42f and 43f in the electrode film masks 42 and 43. During the resist pattern forming step, even when the exposure openings 42f and 43f of the electrode film masks 42 and 43 different from the electrode film masks 42 and 43 which should be originally use are aligned with the through holes S5 and S6, the shapes of the exposure openings 42f and 43f in plan view are not consistent with the shapes of the through holes S5 and S6 in plan view, and the entire part of the through holes S5 and S6 cannot be exposed from the exposure openings 42f and 43f. Thus, it becomes possible to prevent a resist pattern from being formed in a state where different types of electrode film masks 42 and 43 are arranged and to suppress the disuse or the like of the wafer S, thereby achieving low cost of the piezoelectric vibrating piece 2.

During the resist pattern forming step, the resist film 50 is applied while the through holes S5 and S6 are covered with the coating member 44. For this reason, it is possible to suppress the unclearness of the shapes of the through holes S5 and S6 in plan view due to the application of the resist film 50, and to reliably align the exposure openings 42f and 43f with the through holes S5 and S6.

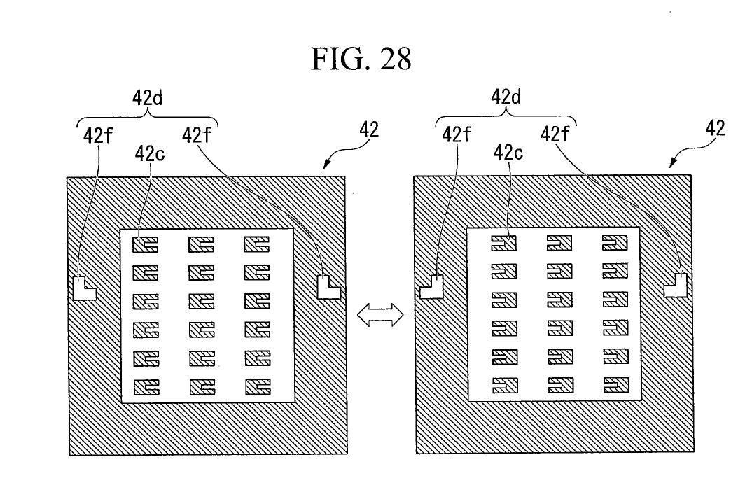

The shapes of the exposure openings 42f and 43f in plan view are asymmetrical in both directions of one direction and another direction. For this reason, as shown in FIG. 28, during the resist pattern forming step, for example, even when the through holes S5 are exposed from the exposure openings 42f in a state where the electrode film mask 42 is inversed in one direction with respect to the normal direction or is inversed in another direction, the entire part of the through holes S5 cannot be exposed. Therefore, it is possible to prevent a resist pattern from being formed in a state where the electrode film masks 42 and 43 are arranged in different directions.

The piezoelectric vibrator 1 of this embodiment includes the piezoelectric vibrating piece 2 manufactured by the method of manufacturing a piezoelectric vibrating piece, thereby achieving low cost.

### (Oscillator)

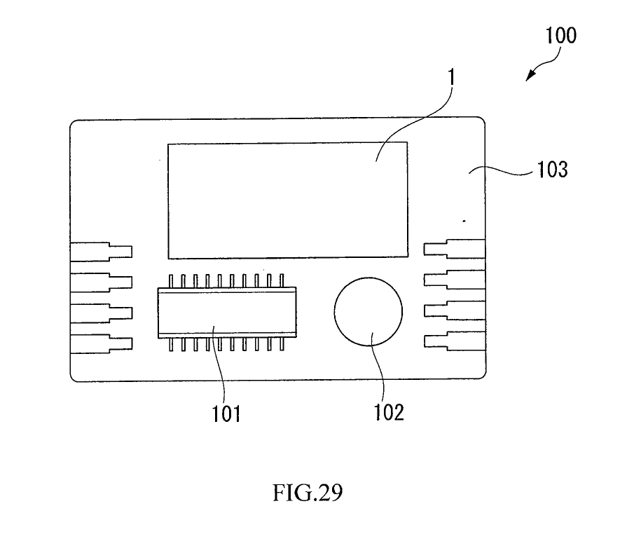

Next, an oscillator according to an embodiment of the invention will be described with reference to FIG. 29.

As shown in FIG. 29, an oscillator 100 of this embodiment is configured as an oscillating element in which the piezoelectric vibrator 1 is electrically connected to an integrated circuit 101. The oscillator 100 includes a substrate 103 on which an electronic component 102, such as a capacitor, is mounted. The above-described integrated circuit 101 for an oscillator is mounted on the substrate 103, and the piezoelectric vibrator 1 is mounted near the integrated circuit 101. The electronic component 102, the integrated circuit 101, and the piezoelectric vibrator 1 are electrically connected to each other by wire patterns (not shown). The constituent components are molded with resin (not shown).

In the oscillator 100 configured as above, if a voltage is applied to the piezoelectric vibrator 1, the piezoelectric vibrating piece 2 in the piezoelectric vibrator 1 vibrates. The vibration is converted to an electrical signal by the piezoelectric characteristics of the piezoelectric vibrating piece 2, and is input to the integrated circuit 101 as an electrical signal. The input electrical signal is subjected to various kinds of processing by the integrated circuit 101 and outputs as a frequency signal. Thus, the piezoelectric vibrator 1 functions as an oscillating element.

The configuration of the integrated circuit 101, for example, an RTC (real time clock) module or the like is selectively set in accordance with the requirements, thereby adding a function of controlling the operation date or time of the corresponding apparatus or an external apparatus or a function of providing time, calendar, or the like, in addition to a single-function oscillator for a timepiece or the like.

As described above, since the oscillator 100 of this embodiment includes the low-cost and reliable piezoelectric vibrator 1, with regard to the oscillator 100 itself, low cost can be achieved. It is also possible to obtain a stable and high-definition frequency signal over a long term.

### (Electronic Apparatus)

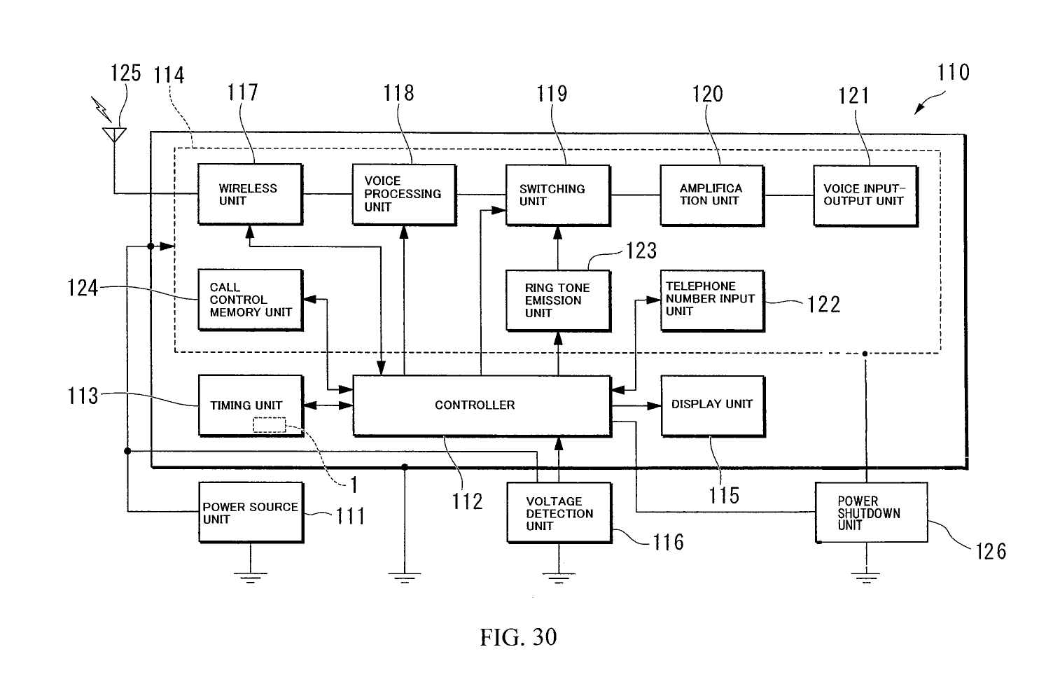

Next, an electronic apparatus according to an embodiment of the invention will be described with reference to FIG. 30. Description will be provided as to an example where a portable information apparatus 110 having the above-described piezoelectric vibrator 1 is used as an electronic apparatus. Initially, the portable information apparatus 110 of this embodiment is represented by, for example, a mobile phone, and is a developed and improved version of a wristwatch in the related art. The appearance is similar to a wristwatch, and a liquid crystal display is arranged in a portion corresponding to a dial plate, such that the current time or the like can be displayed on the screen. When an electronic apparatus is used as a communication tool, the user removes the electronic apparatus from the wrist and can perform communication as with a mobile phone in the related art using an internal speaker and a microphone inside a band. The size and weight are significantly reduced compared to a mobile phone in the related art.

Next, the configuration of the portable information apparatus 110 of this embodiment will be described. As shown in FIG. 30, the portable information apparatus 110 includes the piezoelectric vibrator 1, and a power supply unit 111 which supplies power. The power supply unit 111 is, for example, a lithium rechargeable battery. A control unit 112 which performs various kinds of control, a timepiece unit 113 which counts the time or the like, a communication unit 114 which performs communication with the outside, a display unit 115 which displays various kinds of information, and a voltage detection unit 116 which detects a voltage at each function unit are connected in parallel to the power supply unit 111. Thus, power is supplied to the respective functional units by the power supply unit 111.

The control unit 112 controls the respective functional units to control the operations of the overall system, such as operations to transmit and receive sound data and operations to measure and display the current time. The control unit 112 includes a ROM in which a program is pre-installed, a CPU which reads and runs the program installed in the ROM, a RAM which is used as a work area of the CPU, and the like.

The timepiece unit 113 includes an integrated circuit in which an oscillation circuit, a register circuit, a counter circuit, an interface circuit, and the like are integrated, and the piezoelectric vibrator 1. When a voltage is applied to the piezoelectric vibrator 1, the piezoelectric vibrating piece 2 vibrates, and the vibration is converted to an electrical signal by the piezoelectric characteristic of crystal and input to the oscillation circuit as an electrical signal. The output of the oscillation circuit is binarized and counted by the register circuit and the counter circuit. Transmission and reception of signals with respect to the control unit 112 are carried out through the interface circuit, and the current time, the current date, calendar information, or the like is displayed on the display unit 115.

The communication unit 114 has the same functions as a mobile phone in the related art, and includes a wireless unit 117, a sound processing unit 118, a switching unit 119, an amplification unit 120, a sound input/output unit 121, a telephone number input unit 122, an incoming call sound generation unit 123, and a call control memory unit.

The wireless unit 117 performs the transmission and reception of various kinds of data, such as sound data, with a base station through an antenna 125. The sound processing unit 118 encodes and decodes a sound signal input from the wireless unit 117 or the amplification unit 120. The amplification unit 120 amplifies a signal input from the sound processing unit 118 or the sound input/output unit 121 to a predetermined level. The sound input/output unit 121 has a speaker, a microphone, or the like, and makes incoming call sound or received sound loud or collects sound.

The incoming call sound generation unit 123 generates incoming call sound in accordance with a call from a base station. The switching unit 119 switches the amplification unit 120 connected to the sound processing unit 118 to the incoming call sound generation unit 123 when a call is received, such that incoming call sound generated by the incoming call sound generation unit 123 is output to the sound input/output unit 121 through the amplification unit 120.

The call control memory unit 124 stores a program relating to incoming/outgoing call control in communication. The telephone number input unit 122 includes, for example, numeric keys from 0 to 9 and other keys. The user depresses the numeral keys and the like to input the telephone number of call destination or the like.

When a voltage applied to each functional unit, such as the control unit 112, by the power supply unit 111 falls below a predetermined value, the voltage detection unit 116 detects the voltage drop and notifies the voltage drop to the control unit 112. The predetermined voltage value at this time is a value which is set in advance as a minimum voltage necessary for stably operating the communication unit 114, and is set to, for example, about 3 V. When receiving the notification of the voltage drop from the voltage detection unit 116, the control unit 112 prohibits the operations of the wireless unit 117, the sound processing unit 118, the switching unit 119, and the incoming call sound generation unit 123. In particular, it is inevitably necessary to stop the operation of the wireless unit 117 which consumes large power. A message that a remaining battery quantity is short and the communication unit 114 is inoperable is also displayed on the display unit 115.

That is, the operation of the communication unit 114 can be prohibited by the voltage detection unit 116 and the control unit 112, and a message that the operation of the communication unit 114 is prohibited can be displayed on the display unit 115. This display may be a text message, and as more intuitive display, a x (cross) mark may be attached to a telephone icon displayed at an upper part of the display screen of the display unit 115.

A power shutoff unit 126 is provided to selectively shut off power of a portion relating to the function of the communication unit 114, thereby more reliably stopping the function of the communication unit 114.

As described above, since the portable information apparatus 110 of this embodiment includes the low-cost and reliable piezoelectric vibrator 1, with regard to the portable information apparatus itself, it is possible to achieve low cost. It is also possible to display stable and high-definition timepiece information over a long term.

### (Radio-Controlled Timepiece)

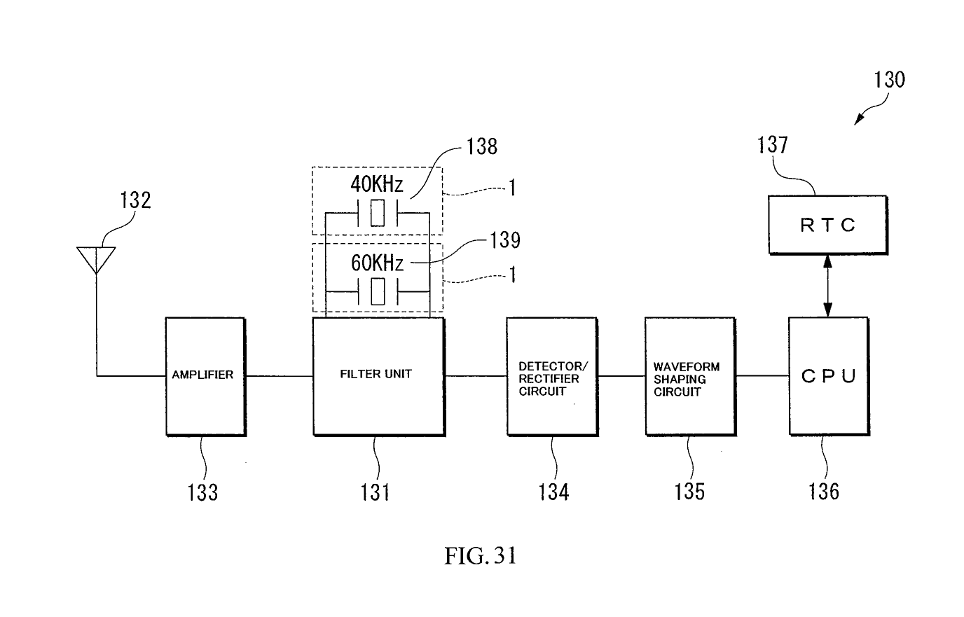

Next, a radio-controlled timepiece according to an embodiment of the invention will be described with reference to FIG. 31.

As shown in FIG. 31, a radio-controlled timepiece 130 of this embodiment is a timepiece which includes the piezoelectric vibrator 1 which is electrically connected to a filter unit 131, and has a function of receiving a standard electric wave including timepiece information, automatically correcting a time to an accurate time, and displaying the corrected time.

In Japan, transmission installations (transmission stations) which transmit the standard electric waves are located in the Fukushima prefecture (40 kHz) and the Saga prefecture (60 kHz) and transmit the standard electric waves. A long wave having a frequency of 40 kHz or 60 kHz has both of property that the wave propagates on the ground and property that the wave propagates while being reflected between an ionosphere and the ground. Hence, a propagation range is wide, such that the standard electric waves can cover all areas of Japan with the above-described two transmission installations.

Hereinafter, the functional configuration of the radio-controlled timepiece 130 will be described in detail.

The antenna 132 receives the standard electric wave of a long wave having a frequency of 40 kHz or 60 kHz. The standard electric wave of a long wave is an electric wave which is obtained through AM modulation of time information called as a time code on a carrier wave having a frequency of 40 kHz or 60 kHz. The received standard electric wave of a long wave is amplified by an amplifier 133, is filtered by a filter unit 131 having a plurality of piezoelectric vibrators 1, and is tuned.

The piezoelectric vibrators 1 of this embodiment respectively include crystal vibrator portions (piezoelectric vibrating pieces) 138 and 139 having resonance frequency of 40 kHz and 60 kHz as same as the above-described frequency of the carrier wave.

A filtered signal having a predetermined frequency is detected and demodulated by a detection and rectification circuit 134.

Subsequently, the time code is extracted through a waveform shaping circuit 135 and is counted by a CPU 136. The CPU 136 reads information on current year, cumulative days, day of week, time, and the like. The read information is reflected on an RTC 137 such that accurate time information is displayed.

The carrier wave has a frequency of 40 kHz or 60 kHz, thus the crystal vibrator portions 138 and 139 preferably have a vibrator having the above-described tuning-fork structure.

Although the above description has been provided as to the radio-controlled timepiece used in Japan, the frequency of the standard electric wave of long wave overseas is different from the standard electric wave in Japan. For example, the standard electric wave having a frequency of 77.5 kHz is used in Germany. Accordingly, in incorporating the radio-controlled timepiece 130 compatible with the oversea use into a portable apparatus, the piezoelectric vibrator 1 having a frequency different from the frequency used in Japan is required.

As described above, since the radio-controlled timepiece 130 of this embodiment includes the low-cost and reliable piezoelectric vibrator 1, with regard to the radio-controlled timepiece itself, it is possible to achieve low cost. It is also possible to count a time stably with high definition over a long term.

The technical scope of the invention is not limited to the above-described embodiment, and various modifications may be made without departing from the gist of the invention.

For example, although in the above-described embodiment, the cylinder package type piezoelectric vibrator 1 has been described as an example of a piezoelectric vibrator, the invention is not limited thereto. For example, a surface-mounted piezoelectric vibrator, a ceramic package type piezoelectric vibrator, or a cylinder package type piezoelectric vibrator 1 may be solidified in a mold resin portion to form a surface-mounted vibrator.

The invention is not limited to the tuning fork type piezoelectric vibrating piece 2 and may be applied to an AT piezoelectric vibrating piece.

The electrode portion 18 is not limited to that in the above-described embodiment insofar as an electrode portion has a plurality of electrode films which are laminated on the outer surface of the piezoelectric plate 11 and have different patterns. For example, three or more electrode films may be laminated.

Although in the above-described embodiment, a positive type is used as the resist film 50, a negative type may be used.

Although in the above-described embodiment, the two wafer-side masks S3 and S4 corresponding to the two electrode film masks 42 and 43 are formed in the wafer S simultaneously with the outline shape of the piezoelectric plate 11, the invention is not limited thereto.

Although in the above-described embodiment, the wafer-side marks S3 and S4 are the through holes S5 and S6, the wafer-side marks S3 and S4 may be concave portions which do not pass through the wafer S.

Although in the above-described embodiment, during the resist pattern forming step, the coating member 44 is arranged on the wafer S, and the resist film 50 is applied while the peripheral portions of the through holes S5 and S6 of the wafer-side marks S3 and S4 corresponding to the electrode film masks 42 and 43 are covered with the coating member 44, the peripheral portions of the through holes S5 and S6 may not be covered with the coating member 44.

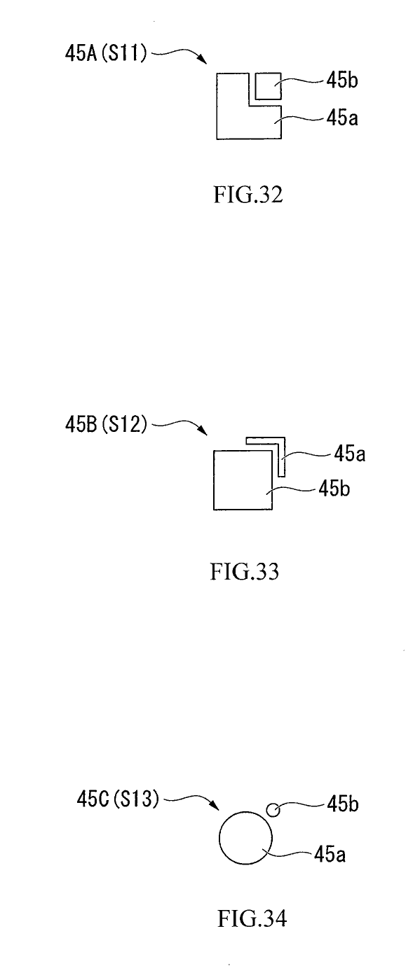

The shapes of the exposure openings 42f and 43f of the first mask 42 and the second mask 43 in plan view and the through holes S5 and S6 of the wafer S are not limited to the above-described embodiment insofar as the shapes of the exposure openings 42f and 43f of the first mask 42 and the second mask 43 in plan view and the through holes S5 and S6 of the wafer S are asymmetrical in both directions of one direction and another direction. The shapes in plan view shown in FIGS. 32 to 34 may be used.

For example, as shown in FIGS. 32 to 34, exposure openings 45A, 45B, and 45C (through holes S11, S12, and S13) may have a plurality of discontinuous portions.

The exposure openings 45A and 45B (through holes S11 and S12) shown in FIGS. 32 and 33 include a first portion 45a having an L shape in which linear portions extending in one direction and another direction are connected to each other, and a second portion 45b which is arranged to face the respective unconnected portions of the linear portions of the first portion 45a in both directions of one direction and another direction. The shape of the second portion 45b in plan view is a square (rectangle) extending in both directions of one direction and another direction. In the exposure opening 45A (through hole S11) shown in FIG. 32, the second portion 45b has a size to be located inward in one direction of the first portion 45a and inward in another direction. In the exposure opening 45B (through hole S12) shown in FIG. 33, the second portion 45b has a size to protrude outward in one direction and to protrude outward in another direction with respect to the first portion 45a.

The exposure opening 45C (through hole S13) shown in FIG. 34 includes a first portion 45a and a second portion 45b which have in a circular shape in plan view and are different in size.

Although in the above-described embodiment, the exposure openings (through holes) are asymmetrical in both directions of one direction and another direction, the exposure openings (through holes) may not be asymmetrical.

Although in the above-described embodiment, the mask-side marks 42d and 43d respectively have pairs of exposure openings 42f and 43f, and the wafer-side marks S3 and S4 respectively have pairs of through holes S5 and S6, the invention is not limited thereto. For example, a mask-side mark may have one exposure opening, and a wafer-side mark may have one through hole.

The constituent elements of the above-described embodiment can be suitably replaced with well-known constituent elements without departing from the gist of the invention, and the above-described modifications may be suitably combined with each other.

What is claimed is:

1. A method of producing piezoelectric vibration pieces comprising:
(a) forming in a wafer a plurality of piezoelectric pieces and wafer marks which comprise pairs of marks formed at predetermined locations in the wafer, wherein each mark has a predetermine shape which is asymmetrical in any directions, each pair presents a unique mark pattern which is asymmetrical in any directions, and the marks are identical to each other in the respective pairs but the marks in a pair are different from the marks in the other pairs;
(b) providing a plurality of masks each comprising a pair of marks identical in mark pattern to a different one of the pairs of marks formed in the wafer;
(c) forming layers of electrode films on the wafer in which the plurality of piezoelectric pieces and the wafer marks are formed;
(d) applying a resist film on the wafer on which the layers of electrode films are formed;
(e) placing one of the masks on the wafer so as to coincide a pair of marks of the one mark with a corresponding pair of marks formed in the wafer;
(f) partially removing the resist film according to a pattern of the mask;
(g) partially removing at least one layer of electrode film using a remnant of the resist film; and
(h) repeating steps (d), (e), (f) and (g) using a different mask.

2. The method according to claim 1, wherein the applying a resist film comprises covering the corresponding mark pair formed in the wafer.

3. The method according to claim 1, wherein a distance between marks is different in the respective pairs.

4. The method according to claim 1, wherein the marks in one pair is in a form of letter “L”.

5. The method according to claim 1, wherein the marks in one pair is in a form of a square with one corner being removed therefrom.

6. The method according to claim 1, wherein the marks of the respective pairs are formed respectively in two opposite margins of the wafer.

7. The method according to claim 1, wherein the mark pairs are arranged in parallel to each other in the wafer.
